(19) United States
(12) Patent Application Publication
(10) Pub. No.: US 2004/0005250 A1
(43) Pub. Date: Jan. 8, 2004

(54) Exhaust-gas catalytic converter and catalytic converter body, preferably for the purification of exhaust gases from internal combustion engines

(76) Inventors: Michael Fischer, Kleinmachnow (DE); Olaf Kannapin, Grossziethen (DE); Andreas Rosenek, Berlin (DE); Andreas Wichmann, Berlin (DE)

Correspondence Address: WILLIAM COLLARD, COLLARD & ROE, P.C., 1077 NORTHERN BOULEVARD, ROSLYN, NY, 11576, US

(21) Appl. No.: 10/454,330

(22) Filed: Jun. 4, 2003

(30) Foreign Application Priority Data
Jun. 4, 2002 (DE) DE 102 25 278.5

(51) Int. Cl. B01D 53/34; F01N 3/08

(52) U.S. Cl. 422/180; 422/176; 422/177

(57) ABSTRACT

An exhaust-gas catalytic converter for the purification of exhaust gases from internal combustion engines comprising: a catalytic converter body having a multi-part jointed housing having a front end for receiving exhaust and a back end for expelling exhaust with the ends forming open cross-sections. The catalytic converter body cross-section has a profile with differing numbers of cells per unit area and to change in a region-specific manner. To control the inflow of exhaust gases into the catalytic converter, there is an inflow device for providing a variable focus which allows a portion of the catalytic converter body to receive exhaust at varying levels. This inflow device opens to varying levels to the catalytic converter body based on low or high exhaust gas outputs.

### CROSS REFERENCE TO RELATED APPLICATIONS

Applicant claims priority under 35 U.S.C. §119 of the German Application No. 102 25 278.5 filed Jun. 4, 2002.

### THE FIELD OF INVENTION

The invention relates to exhaust-gas catalytic converters and their catalytic converter bodies, preferably for the purification of exhaust gases from internal combustion engines.

The document DE 29 24 592 A1, incorporated herein by reference, has disclosed exhaust-gas catalytic converters of the generic type. In this design, the metallic catalytic converter body through which exhaust gas flows comprises a rolled-up unit which has been formed from a planar metal support sheet with a catalytically active layer and a metal support sheet which is profiled in a trapezoid, zigzag or wave shape and has a catalytically active layer. The metal support sheets which have been rolled up parallel to one another are each connected at the parts which touch one another and thus form the individual flow passages. The catalytic converter body is surrounded by a multipart, joined housing, having end sides which have open flow passages to receive inflow and outflow of exhaust gases.

The document DE 40 24 942 A1, incorporated herein by reference, has already disclosed exhaust-gas catalytic converters having a plurality of catalytic converter sections which are arranged in series, one behind the other and each having flow passages with differently sized cross sections. In the direction of flow, the exhaust gas firstly flows through a catalytic converter section with large flow passages, then a catalytic converter section with medium-sized flow passages and finally, a catalytic converter section with narrow flow passages. In this design too, the catalytic converter sections through which exhaust gas flows in succession in each case, comprise a rolled-up unit, metal support sheets which have in each case been profiled to different depths in the shape of a trapezoid, zigzag or wave, next to one another and are provided with a catalytically active layer being wound up together with a common planar metal support sheet.

The documents DE 694 05 062 T2 and EP 0 636 41.0 B1 incorporated herein by reference have disclosed ceramic catalytic converters with thin-walled cells and rectangular or hexagonal clear cross sections of flow. Advantages of this invention are, firstly, the low wall thicknesses in order to reduce the exhaust-gas back pressure and the uptake of heat by the carrier material while retaining a constant isostatic strength and, secondly, a higher number of cells to increase the active catalytic converter surface area. The open end faces of the cells are uniformly quadrilateral or hexagonal.

The documents DE 37 38 538 A1 and DE 39 03 803 A1, incorporated herein by reference, have already described controlling the incoming flow of the exhaust gases to exhaust-gas catalytic converters via suitable devices wherein when there is a low throughput of exhaust gas, only some of the axially open flow passages are exposed to flow.

Furthermore, DE 34 39 891 A1, incorporated herein by reference, has already disclosed fixed guide bodies upstream of the catalytic converter, which are intended to ensure uniform flow onto the catalytic converter surface.

The document DE 43 11 904 C2, incorporated herein by reference, has already disclosed exhaust-gas catalytic converters which are divided over their cross section. An inner, cylindrical partial cross section is surrounded by an annular partial cross section, the two partial cross sections being separated by a wall. The two parts can be exposed to exhaust gas separately; the inner part of the catalytic converter body is fed by the turbine of a turbocharger and the outer, annular part is fed via a bypass valve. This type of exposure to exhaust gas in a design of this type results in more rapid light-off and sufficient heating of the catalytic converter, with the result that pollutants start to be removed from the exhaust gases quickly and effectively even at low loads. At higher loads, excessive thermal loading is avoided by all or the majority of the flow passages being exposed to exhaust gas.

To achieve a high degree of conversion of the pollutants while, at the same time, minimizing the pressure loss in catalytic converters, it is already known from document DE 37 13 209 C2 incorporated herein by reference to form coated passage shapes whose width varies between 3 and 8 mm and whose height varies between 0.65 and 0.9 mm. Designs of this type have been described both for wound and for coated honeycomb bodies with passages which are stamped in an arrow shape or to cross one another in metal sheets which adjoin one another. Varying the height, with the associated different boundary disturbances to the flow, results in different surface area ratios with respect to the cross section of flow.

The designs described above, suffer from the drawback when the catalytic converter is cold, and then in the process of being heated, there is a reduced fuel economy and reduced processing of exhaust gas in the transition from cold to hot. For example, after an engine cold start, in the exhaust-gas test cycle at low load, all the flow passages of the cold catalytic converter are exposed to a relatively low and relatively cool mass flow of exhaust gas. Thus, to improve catalytic converters and to solve the above problem, increasing the number of cells per unit area and thereby increasing the reactive surface area does improve the light-off performance. However, it is even better if the catalytic converter comprises two monoliths and forms what is known as a stepped catalytic converter. The first monolith is designed with a high number of cells and a large surface area with a small cross-sectional area, and a second monolith has a smaller number of cells and a smaller surface area with a larger cross-sectional area.

However, the stepped catalytic converter in the cold-start range at low loads constitutes a drawback when the catalytic converter is at its operating temperature and the engine is running at high loads and speeds, since the first monolith, with a high number of cells and a large surface area, reduces the engine performance on account of the increased exhaust-gas back pressure. This causes an increased fuel consumption. Moreover, the first monolith, which generally has thin-walled cells, is subject to increased thermal loads from the hot exhaust gas flowing through the narrow cross sections, in particular when the catalytic converter is positioned close to the engine. This reduces the service life of the catalytic converter.

Thus, the invention is based on the object of providing a catalytic converter structure having monoliths which are favorable in terms of performance, consumption, and durability and which allow rapid heating and high conversion rates even at low engine operating points, without suffering from the drawbacks related to reduced engine performance. Thus, the invention provides a catalytic converter support, starting from its cross-sectional area which is exposed to the incoming flow and has regions with different numbers of cells per unit area. An inflow device applies exhaust gas to the regions with different numbers of cells per unit area of the cross-sectional area exposed to incoming flow as a function of the engine operating point and the exhaust-gas temperature or the catalytic converter state.

Immediately after an engine cold start and while the engine is warming up, with low exhaust-gas mass flow rates, the exhaust gas is directed onto the region of the catalytic converter having a cross-section with a high number of cells and a large surface area by the inflow device. The large reactive surface area in this region exposed to incoming flow and the reduced heated thermal mass compared to the catalytic converter body as a whole, result in the full conversion capacity of the catalytic converter being reached more quickly.

At higher loads, and therefore higher exhaust-gas temperatures, the region which is exposed to incoming flow is widened and in this way, the entire catalytic converter body is heated to its operating temperature.

At engine operating points which are close to, and at full load, the inflow device can cause the region with a small number of cells and a smaller surface area, but a larger cross-sectional area to be acted on by a higher specific exhaust-gas mass flow than the catalytic converter cross-sectional region with a high number of cells and a large surface area.

This change or addition of a new region reduces the exhaust-gas back pressure, with the result that the engine efficiency rises and the fuel consumption is reduced. At the same time, relief is provided for the catalytic converter cross-sectional region with a high number of cells and a large surface area, which is more reactive because of the larger specific surface area and is therefore subject to higher loads in terms of temperature.

In addition to the advantages of the rapid light-off even at a low throughput of exhaust gas in the catalytic converter, the reduced fuel consumption and the increased: service life, the catalytic converter support described in the present invention also takes up less space than conventional stepped or cascaded catalytic converters.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 shows a catalytic converter support which is wound from metal foils and has an inhomogeneous cell structure;

FIG. 2 shows a ceramic catalytic converter support with a square, inhomogeneous cell structure;

FIG. 3 shows a ceramic catalytic converter support with a hexagonal, inhomogeneous cell structure;

FIG. 4a shows a metal support sheet which profiled in a rising/falling (amplitude and frequency) trapezoid, zigzag or wave shape;

FIG. 4b shows a metal support sheet design which is profiled in a rising/falling (amplitude and frequency) trapezoid, zigzag or wave shape

FIG. 5a shows a metal support sheet design which is designed such that it is profiled to change symmetrically starting from the center of the metal sheet, in trapezoid, zigzag or wave shape;

FIG. 5b shows a metal support sheet design which is designed such that it is profiled to change symmetrically starting from the center of the metal sheet, in trapezoid, zigzag or wave shape;

FIG. 6 is a cross sectional view of the device showing a first embodiment of an inflow device;

FIG. 7 is a cross-sectional view of the device showing a second embodiment of the inflow device; and

FIG. 8 is a cross-sectional view of the device showing a third embodiment of the inflow device.

### DETAILED DESCRIPTION

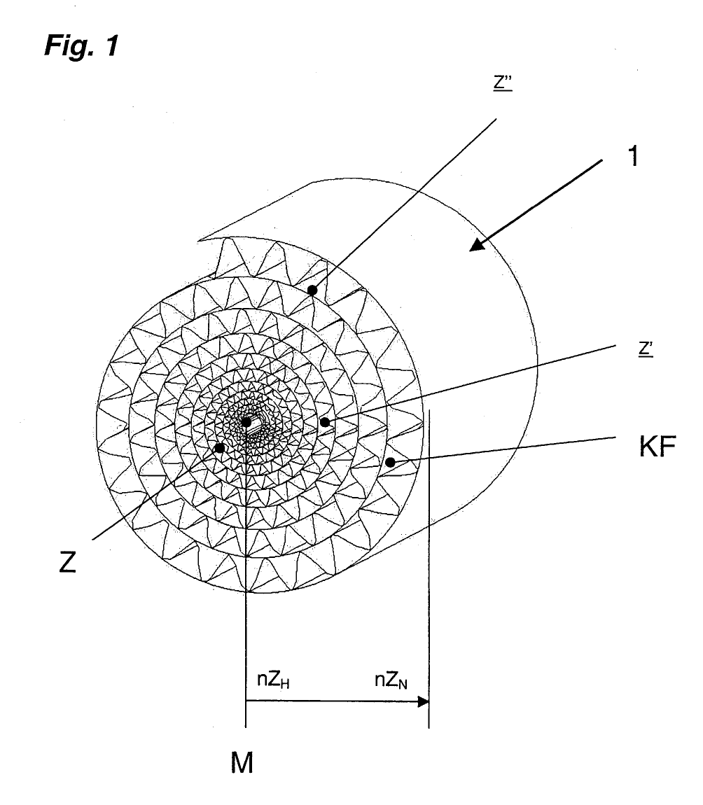

Referring to the drawings, FIG. 1 shows a wound metallic catalytic converter body 1 with an inhomogeneous cell structure, for example, the number of cells per unit area decreases helically from the center M outward. As a result, a region with a high number of cells nZH per unit area is formed on the inside and a region with a low number of cells nZN per unit area is formed on the outside. The wall thicknesses are identical for all the cells Z; Z′; Z″.

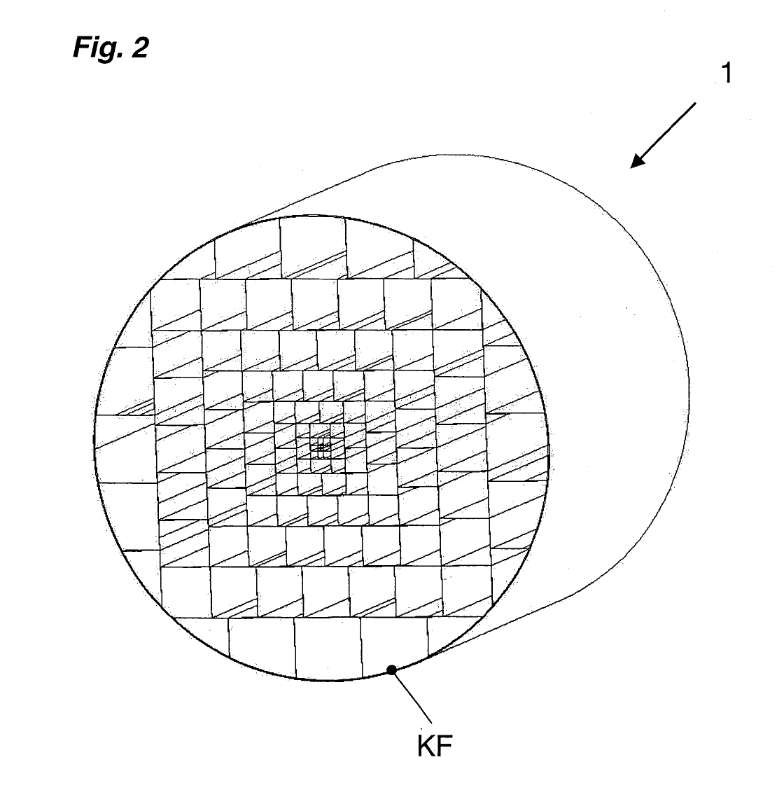

FIG. 2 shows a ceramic catalytic converter body with an inhomogeneous cell structure and a square passage cross section. Because thin-walled ceramic catalytic converter bodies have a lower thermal conductivity than metallic catalytic converter bodies, they allow more rapid heating and therefore, allow the full operating capacity to be achieved more quickly.

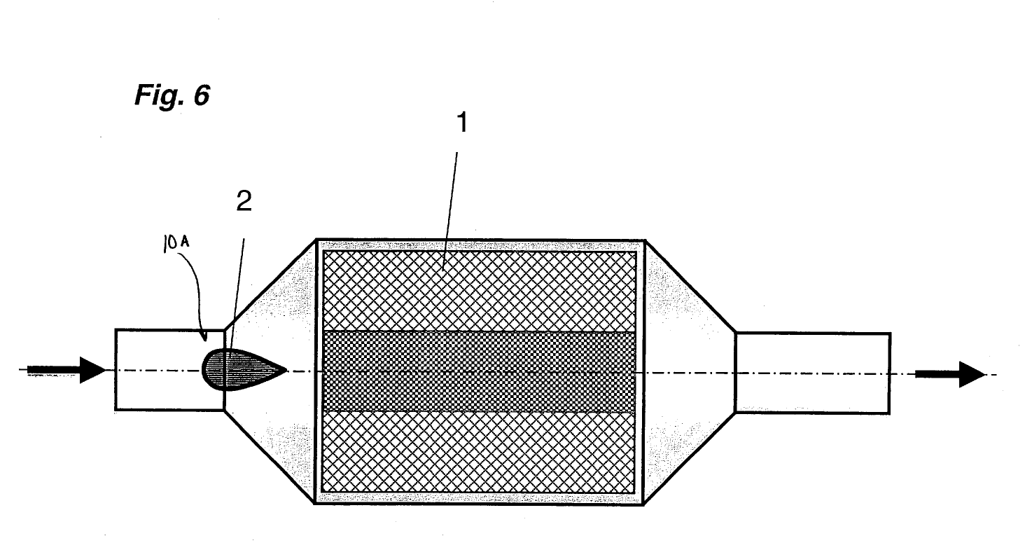

The combination of, for example, a high number of cells nZH in the center of the catalytic converter body 1 and the use of a focusing inflow device as described in German Patent DE 37 38 538 A1 and German Patent DE 39 03 803 A1 incorporated herein by reference, makes it possible to advantageously control the incoming flow of the exhaust gases to catalytic converter body 1. The control may also be performed as a function of flow by guide bodies in accordance with German Patent DE 34 39 891 A1, incorporated herein by reference, and the guide devices described in FIGS. 6 to 8. At a low exhaust-gas throughput, only some of the axially open flow passages, in the region with a high number of cells nZ_{H} per unit area, are exposed to the flow of exhaust gas, while at a high exhaust-gas throughput, all the flow passages are exposed to the flow of exhaust gas.

Depending on the inflow device used, the high number of cells nZH per unit area may be arranged either in the center M, of the catalytic converter cross section, or on the outside.

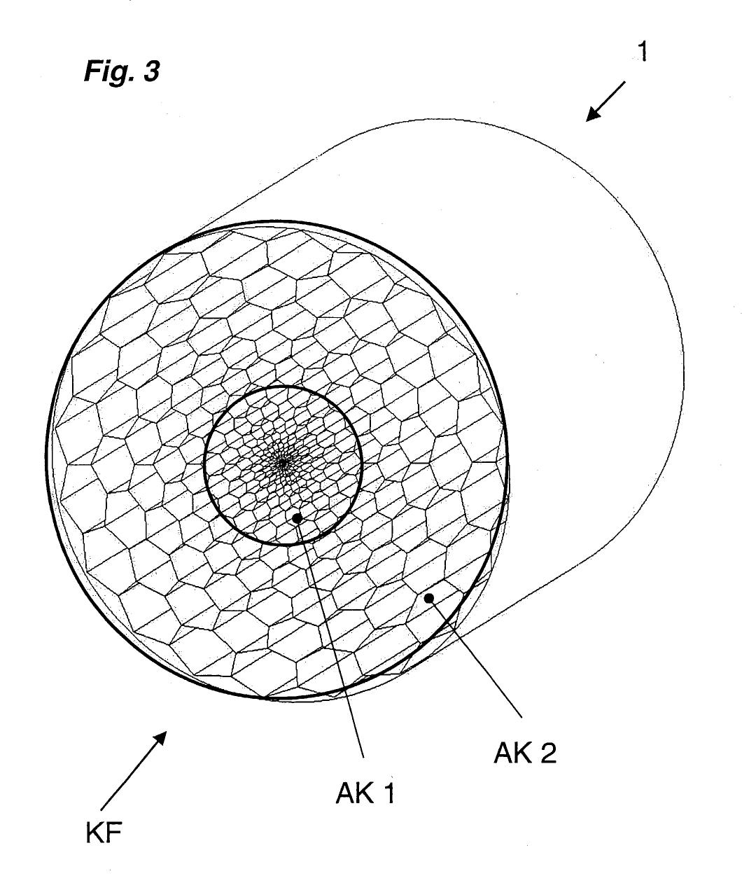

It is also possible to use an inflow device with separate inflow passages AK 1 and AK 2 for low and high exhaust-gas throughputs arranged concentrically with respect to one another. In this case, the inflow passages AK 1 and AK 2 are acted on by groups of exhaust valves of the engine cylinders which open to different extents. In FIG. 3, the cross sections of the inflow passages AK 1 and AK 2 are diagrammatically indicated by means of their areas upstream of the catalytic converter cross-sectional area KF.

FIG. 3 shows a ceramic catalytic converter body 1 with hexagonal passage cross sections in the form of honeycombs. Body 1 has an inhomogeneous cell structure which has increased static strength compared to a support with rectangular passage cross sections. This arrangement combined with a focusing inflow device of the types described above results in an improved catalytic converter with improved performance.

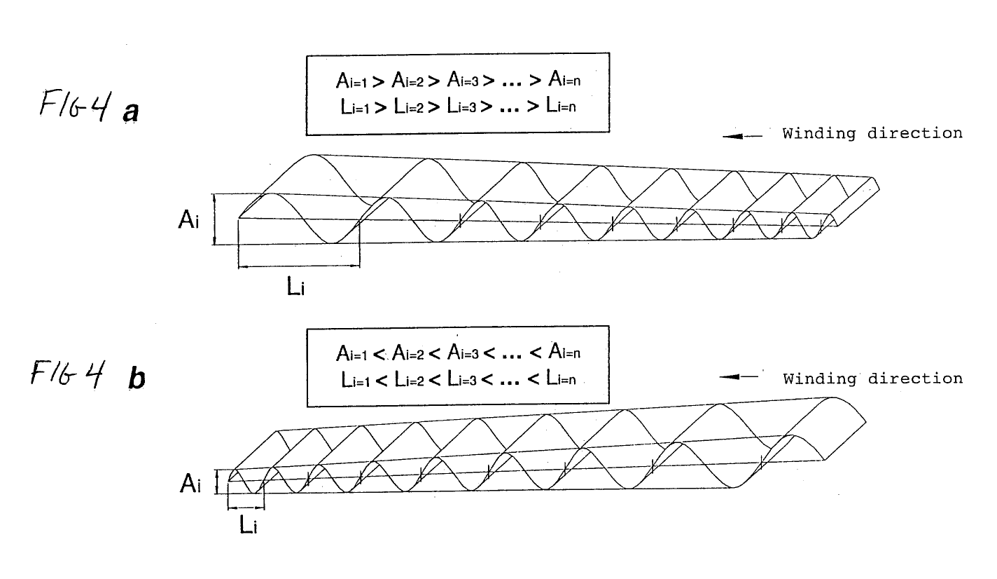

FIGS. 4a and 4b show exemplary embodiments of a catalytic converter body made from metal and constructed from metal support sheets. The trapezoid, zigzag or wave shape of the profiled metal support sheet, is designed to have a continuous change in height Aₘᵢₙ to Aₘₐₓ and width Lₘᵢₙ to Lₘₐₓ. This occurs over some or all of the length which is required to form a catalytic converter body by winding, and results in the number of cells per unit area differing over the catalytic converter cross section.

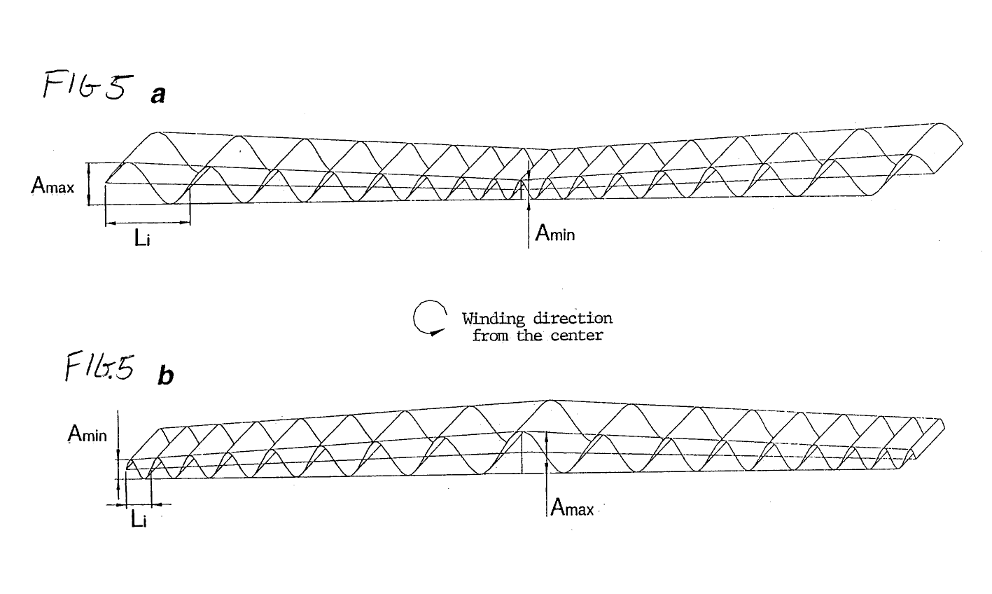

FIGS. 5a and 5b show another embodiment of metal support sheets. The metal support sheets which are profiled in a trapezoid, zigzag or wave shape may also have a wave shape which increases or decreases in size in opposite directions. In this case, each winding, together with the planar metal sheet starts from the center of the metal support sheet.

Another embodiment of the invention of the metal support (not shown) can be made from sheet-metal segments which are joined together and have different depths of profile. According to the invention, it is also possible to use a multipart catalytic converter body 1 which comprises a core which can be formed from one or more concentric rings. The core and/or the concentric rings have a number of cells per unit area which increases or decreases in steps from one part to another, starting from the center of the cross-sectional area of the catalytic converter. A design of this type is not illustrated.

In operation, catalytic converters are subject to may different loads such as, mechanical, thermal and fluid-dynamic loads and have to comply with manufacturing technology criteria. In addition, during installation, ceramic catalytic converter bodies are subjected to prestress. The resulting demands imposed on the dimensions of the wall thicknesses of the catalytic converter body can be considered in the present invention.

Thus, to ensure mechanical compressive strength of the ceramic catalytic converter bodies, the wall thicknesses can be dimensioned so that each cell wall has the same strength. Thus, despite having an inhomogeneous cell structure, with different side lengths of the partitions, the catalytic converter body forms a component of uniform strength.

FIGS. 6, 7 and 8 show variants of the inflow units 10a, 10b and 10c for the catalytic converter for controlling the number of cells (Z; Z′; Z″) per unit area which form the catalytic converter cross-sectional area (KF) (cf. FIGS. 1-5). Inflow units 10a, 10b, 10c are designed to vary the size of the cross sectional area of the catalytic converter receiving exhaust gases differently in a region-specific manner. In a simple configuration as shown in FIG. 6, inflow unit 10a comprises a stationary guide device 2 that is arranged upstream of catalytic converter body 1. With this design, the incoming exhaust gases are applied to the catalytic converter surface area in different ways depending on the flow conditions.

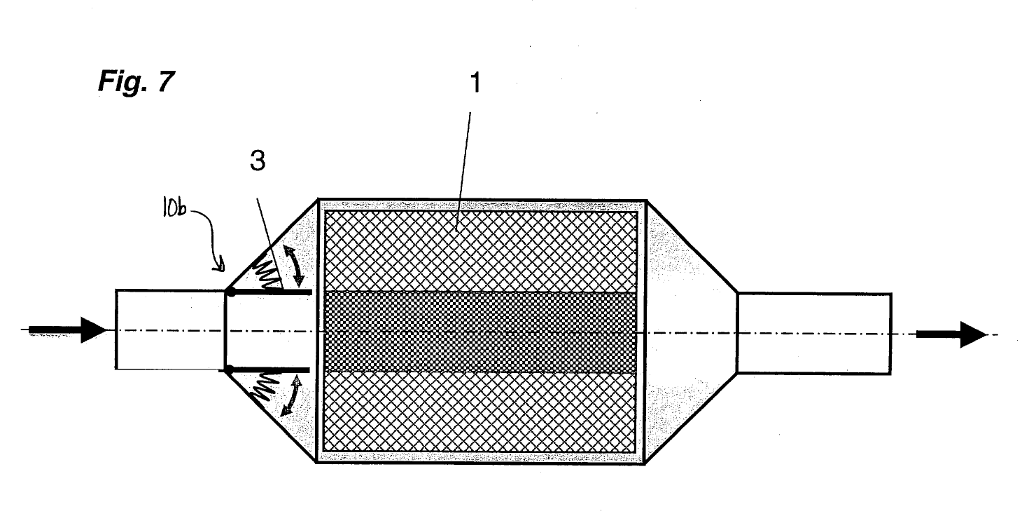

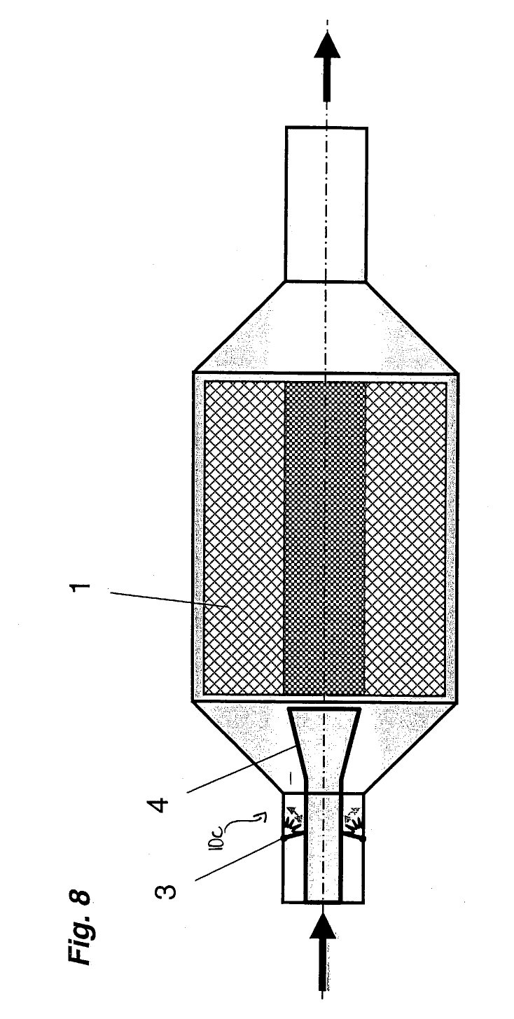

FIG. 7 shows an additional configuration of inflow device 10b, which shows spring-loaded guide devices, preferably in the form of pivotable guide flaps 3, which are arranged upstream of catalytic converter body 1, based on the direction of incoming flow. In another embodiment (not shown), the guide devices may be arranged in the flow path downstream of the catalytic converter body 1. Pivotable guide flaps 3 may be operated as follows: in a first embodiment, these guide flaps are biased by spring 30 in a first position and extend substantially parallel to a longitudinal axis of catalytic converter body, and also substantially parallel to the direction of flow of the exhaust gases. Thus, when exhaust gases are released at an increasing rate, the increasing pressure forces the flaps open against the springs to allow these gases to reach a wider area of catalytic converter body 1. In a second embodiment, flaps 3 can be opened by an electronic relay that signals that these flaps should rotate open. This same type system is used in the device shown in FIG. 8.

FIG. 8 shows another embodiment of the inflow device 10c, wherein, in addition to an inner; tube, which may be designed as a diffuser 4, spring-loaded guide flaps 3 apply exhaust gas to different regions of the catalytic converter as a function of the flow conditions.

Accordingly, while at least one embodiment of the present invention has been shown and described, it is to be understood that many changes and modifications may be made thereunto without departing from the spirit and scope of the invention as defined in the appended claims.

In the claims:

1. An exhaust-gas catalytic converter for the purification of exhaust gases from internal combustion engines comprising:
a) a catalytic converter body having a multi-part joined housing having a front end for receiving exhaust and a back end for expelling exhaust with said ends forming open cross sections and whereas said catalytic converter body cross-section has a profile with differing numbers of cells per unit area which change in a region-specific manner; and
b) an inflow device disposed upstream of said catalytic converter body, for providing variable focus on said cross section of said front end, wherein said inflow device allows a portion of said catalytic converter body to receive exhaust at varying levels wherein said inflow device opens to varying levels to said catalytic converter body based upon low or high exhaust gas outputs.

2. The exhaust-gas catalytic converter as claimed in claim 1, wherein said number of cells per unit area increases from the center of the cross section of the catalytic converter body toward an outer edge region of said cross-section.

3. The exhaust-gas catalytic converter as claimed in claim 1, wherein said number of cells per unit area decreases from the center of the cross section of the catalytic converter body toward an outer edge region of said cross-section.

4. The exhaust gas catalytic converter as in claim 1, wherein said catalytic converter body has a first region with a relatively high number of cells per unit area and a second region with a relatively low number of cells per unit area.

5. The exhaust-gas catalytic converter as claimed in claim 1, wherein, in a cold state and under low engine loads, said catalytic converter body is exposed to an inflow of exhaust-gas in said region with a relatively high number of cells per unit area.

6. The exhaust-gas catalytic converter as claimed in claim 1, wherein said catalytic converter body has a first region for receiving a first level of inflow exhaust gas and a second region concentrically arranged relative to said first region for accepting a second level of inflow of exhaust gas.

7. The catalytic converter as in claim 1, wherein said catalytic converter body is formed as a plurality of individual units, each having a catalytic layer and wherein each of said individual units is designed such that its height and width changes continuously.

8. The catalytic converter as in claim 7, wherein said catalytic converter body is formed from flat metal support sheets which are in a trapezoidal shape.

9. The catalytic converter as in claim 7, wherein said catalytic converter body is formed from flat metal support sheets which are in a zigzag shape.

10. The catalytic converter body as in claim 7, wherein said catalytic converter body is formed from flat metal support sheets which are in a wave shape.

11. The catalytic converter as in claim 1, wherein said catalytic converter body is formed as a plurality of rolled up units joined to one another comprising a plurality of flat metal support sheets including at least one flat metal support sheet which is profiled in a trapezoidal manner and wherein said metal support sheets which are rolled up parallel to one another, are used to form said cells, which are designed to continuously change in height and width.

12. The catalytic converter as in claim 1, wherein said catalytic converter body is formed as a plurality of rolled up units joined to one another comprising a plurality of flat metal support sheets including at least one flat metal support sheet which is profiled in a zig-zag manner and wherein said metal support sheets which are rolled up parallel to one another, are used to form said cells, which are designed to continuously change in height and width.

13. The catalytic converter as in claim 1, wherein said catalytic converter body is formed as a plurality of rolled up units joined to one another comprising a plurality of flat metal support sheets including at least one flat metal support sheet which is profiled in a wave shaped manner and wherein said at least one flat metal support sheet which is rolled up parallel to one another used to form said cells, which are designed to continuously change in height and width.

14. The catalytic converter as in claim 1, wherein said catalytic converted body is formed as a plurality of individual units which are joined to each other each having a catalytic layer and wherein each of said individual units is designed such that its height and width changes at each attached partial sheet.

15. The catalytic converter as in claim 1, wherein said catalytic converter body is made from ceramic and comprises honeycombs of a polygonal cross-section.

16. The catalytic converter as in claim 15, wherein said catalytic converter body comprises a core and/or at least one concentric ring, wherein said core and said at least one concentric ring each have a number of cells per unit area which decreases in steps from part to part starting from a cross-sectional center of the catalytic converter.

17. The catalytic converter as in claim 15, wherein said catalytic converter body comprises a core and/or at least one concentric ring, wherein said core and said at least one concentric ring each have a number of cells per unit area which increases in steps from part to part starting from a cross-sectional center of the catalytic converter.

18. The catalytic converter as claimed in claim 15, wherein said honeycombs have wall thicknesses which are dimensioned suitably for mechanical strength requirements, thermal and fluid-dynamic load requirements and any manufacturing technology requirements.

19. The catalytic converter as in claim 1, wherein said inflow device of variable focus, which allows exhaust gas to act on some or all of the inlet surface area of the catalytic converter body, comprises at least one pivotable, spring-loaded guide device.
